(19) United States
(12) Patent Application Publication
(10) Pub. No.: US 2017/0341976 A1
(43) Pub. Date: Nov. 30, 2017

(54) ONE-PIECE, TRANSPARENT ANTI-CONDENSATION SUBSTRATE

(71) Applicant: SAINT-GOBAIN GLASS FRANCE, Courbevoie (FR)

(72) Inventors: Fabio FOTI, Paris (FR); Frédéric GODMER, Paris (FR)

(21) Appl. No.: 15/520,941

(22) PCT Filed: Oct. 21, 2015
(86) PCT No.: PCT/FR2015/052827

§ 371 Date: Apr. 21, 2017

(30) Foreign Application Priority Data
Oct. 24, 2014 (FR) 1460225

(51) Int. Cl. C03C 17/32; C03C 17/30; C03C 17/34

(52) U.S. Cl. CPC C03C 17/322; C03C 17/34; C03C 17/30; C03C 2218/365; C03C 2217/75

(57) ABSTRACT

A method includes applying a monolithic transparent substrate for separating a chamber cooled to a temperature of 0 to 4° C. from an ambient atmosphere, wherein a face of the monolithic transparent substrate in contact with the cooled air is provided with a low-emissivity layer, and another face of the monolithic transparent substrate in contact with the ambient atmosphere is provided with an anti-condensation layer

The present invention relates to the storage and presentation for sale of products, in general food products, at a temperature centered about 0 to 4° C., i.e. that may reach values slightly lower or slightly higher than this range, nevertheless commonly referred to as “refrigeration above 0° C”.

These products are generally placed on shelves in direct communication with the atmosphere of the store. Close to these shelves, the customers frequently feel the cold. The heating of the store should optionally be adapted for this purpose. The production of refrigeration requires increased energy due to the communication of the cold shelf with the atmosphere of the store.

The inventors have now thought of insulating these cold shelves with a transparent wall.

Glazed doors of chambers refrigerated to temperatures as low as −18° C., or even −25° C., etc. are already known. The problem posed by these freezer doors is in particular that of the frost that forms upon opening on the cold face thereof on the chamber side. Indeed, during this opening, the ambient humidity of the store condenses on the cold face and crystallizes into frost. In order to resolve this, means for heating this cold face of the door are provided in order to eliminate the frost so as to restore proper vision through the door.

In order to eliminate or at least reduce these means for heating the freezer door, application WO 00/71481 envisages coating the cold face of the freezer door with an anti-frost layer. On opening the door, this layer absorbs the humidity which is condensed, and also adsorbs it throughout hydrophilic macromolecular chains that it contains. The absorption is obtained by a polymer material suitable for gradually filling up in the manner of a sponge; one example thereof is a polyurethane matrix. By adsorbing the water of condensation, the hydrophilic macromolecular chain such as polyvinylpyrrolidone, interpenetrated with the polyurethane matrix, is charged with a thin coating of water. If the anti-frost layer is thick enough not to be saturated with water of condensation, depending on the opening time of the door, no visible condensation, crystallized into frost, is formed.

As disclosed in particular by application WO 2006/125874, these glazed freezer doors advantageously consist of double or triple, thermally insulating multiple glazing units. Thus, the hot face of the door, in contact with the atmosphere of the store, is easily maintained at a temperature above the dew point, so that no condensation of fogging occurs.

On the other hand, by thinking of closing off a shelf having refrigeration above 0° C. with a monolithic glass sheet, the inventors have become aware of the real existence of a risk that the hot face of the monolithic glass, in contact with the ambient air of the store, is at a temperature below the dew point (17° C. at 25° C. and 60% relative humidity), and that consequently fogging appears and obstructs the vision through the glass of the products on sale.

For this purpose, one subject of the invention is a monolithic transparent substrate characterized in that it comprises a low-emissivity layer on a first face and an anti-condensation layer on the second face. A low-emissivity layer denotes here a layer having an emissivity of between 1 and 15%. Placed on the cold side of the substrate, it has the role of reflecting a maximum proportion of the thermal radiation from the hot side of the substrate, i.e, the store atmosphere side. The low-emissivity layer therefore normally increases the temperature of the opposite side of the substrate, to a value above the dew point under the aforementioned temperature and humidity conditions. If however the temperature of the cold side drops, or if the temperature of the hot side increases or else if the relative humidity of the hot side increases, a slight condensation is optionally capable of forming on the hot face of the substrate, but in the form of a uniform film of water that does not obstruct vision through the substrate, owing to the anti-condensation layer with which the hot face of this substrate is provided. The anti-condensation layer prevents the formation of fogging, consisting of droplets of water.

Moreover, within the definition of the invention, the term “layer” denotes either a single layer or else a stack of layers, both for the low-emissivity layer and the anti-condensation layer.

According to preferred features of the substrate of the invention:

the anti-condensation layer comprises at least one of the polymer materials selected from polyurethane, polyacetal, polyester, poly(vinyl alcohol), poly(acrylic acid), polyethylene glycol, polypropylene glycol, polyol, polyvinylpyrrolidone, polyvinylpyridine, polyacrylate, polyacrylonitrile, polyacrylamide, polyacrolein, poly(vinyl acetate), silane or a copolymer of several of these, alone or as a mixture of several thereof;

the anti-condensation layer is based on polyurethane;

the anti-condensation layer comprises a polyurethane matrix with which polyvinylpyrrolidone molecules are interpenetrated;

the anti-condensation layer has a thickness of between 5 and 80 μm, preferably 10 and 70 μm and particularly preferably at most equal to 60 μm;

the anti-condensation layer forms the free, i.e. exposed to the outside atmosphere (for example of the store), main surface of an anti-fogging adhesive film, the other main surface of which is adhesive; this film comprises a core consisting in particular of a flexible polymer material of ethylene-vinyl acetate (EVA) or the like; the anti-fogging adhesive film is removable and replaceable;

the substrate is made of a mineral glass material, in particular soda-lime float glass or an organic polymer such as polycarbonate, poly(methyl methacrylate), etc.

Another subject of the invention is the application of the substrate described above for separating a chamber cooled to a temperature of 0 to 4° C. from an ambient atmosphere. This temperature of 0 to 4° C. refers here to the setpoint temperature of the chamber, i.e. a value about which the temperature may fluctuate more or less depending on the location in the chamber, and also of course depending on the time elapsed since the last opening of the separation formed by the substrate. A reference (store interior) ambient atmosphere is defined, for the requirements of the invention, by a temperature of 25° C. and a relative humidity of 60%. As explained above, it is the face of the substrate intended to be in contact with the cooled air that is provided with the low-emissivity layer, and the one intended to be in contact with the ambient atmosphere of the store that is provided with the anti-condensation layer.

Another subject of the invention consists of the application of a substrate as described above as glazing for a land, air or aquatic transport vehicle, in particular for a motor vehicle. The face of the glazing in contact with the outside atmosphere is provided with the low-emissivity layer and the other face on the side of the passenger compartment of the vehicle is provided with the anti-condesation layer. Under a broad range of customary usage conditions of a motor vehicle, a perfect anti-fogging functionality can thus be obtained.

The invention is now illustrated by the following example.

### EXAMPLE

Sheets of soda-lime float glass of 500 mm×1325 mm and 4 or 6 mm thick are coated with a low-emissivity layer on a first face, and with an anti-condensation layer on the second face,

Use is made, as low-emissivity layers, of the following stacks, classified by increasing emissivity (in %):
3%: glass/SnZnO 25 nm/ZnO 5 nm/Ag 10 nm/ZnO 5 nm/NiCr 1 nm/ZnO 5 nm/SnZnO 30 nm/TiOx 3 nm;
7%; glass/SnZnO 25 nm/ZnO 5 nm/Ag 6 nm/ZnO 5 nm/NiCr 1 nm/ZnO 5 nm/SnZnO 30 nm/TiOx 3 nm;
10%: glass/Si₃N₄ (5 nm)/SiO₂ (40 nm)ITO (150 nm)/SI₃N₄ (12 nm)/SiO₂ (75 nm)/TiO₂ (4 nm) and
15%: glass/SnO₂ (30 nm)/SiO₂ (30 nm)/SnO₂:F (370 nm).

In tests numbered 1 to 6, use is made, as anti-condensation layers, of the anti-frost and anti-fogging layers sold by Saint-Gobain Glass under the registered trademark Everclear®, having a thickness as indicated below. These layers consist of a polyurethane matrix with which polyvinylpyrrolidone molecular chains are interpenetrated.

In tests 7 to 14, use is made, as anti-condensation layers, of hydrophilic layers obtained by grafting silanes with a poly(ethylene oxide) (PEO) chain to the glass substrate. The silanes used for the anti-fogging coatings comprise a hydrophilic poly(ethylene oxide) (PEO) chain and three OH groups bonded to the Si atom; the OH groups of the silane react (condensation) with the OH groups of the glass forming silanol (Si—O—Si) bonds. The silanes may also be fluorinated in order to impart self-cleaning properties. Two silanes were used:
a) in tests nos. 7 to 10, the silane sold by Gelest under the reference Silane SiH6188 and of formula:

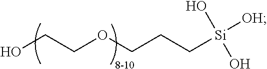

and
b) in tests nos, 11 to 14, the fluorosilane sold by Specific Polymers under the reference SP-SG 192-193 and of formula:

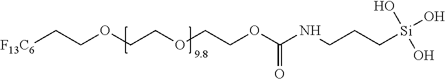

The glass sheets are positioned so as to delimit a refrigerated chamber at a setpoint temperature of 0° C. The ambient atmosphere is at 25° C. and 60% relative humidity. The low-emissivity layer is on the refrigerated chamber side and the anti-condensation layer is on the “ambient atmosphere” side.

The conditions of the fourteen tests are recorded in the table below.

| Test | Glass thickness | Layer emissivity | Anti-condensation |
|---|---|---|---|
| no. | (mm) | (%) | layer thickness |
| 1 | 4 | 3 | 20 μm |
| 2 | 4 | 7 | 20 μm |
| 3 | 6 | 10 | 40 μm |
| 4 | 6 | 15 | 40 μm |
| 5 | 6 | 10 | 50 μm |
| 6 | 6 | 15 | 50 μm |
| 7 | 4 | 3 | Several nm |
| 8 | 4 | 7 | Several nm |
| 9 | 6 | 10 | Several nm |
| 10 | 6 | 15 | Several nm |
| 11 | 4 | 3 | Several nm |
| 12 | 4 | 7 | Several nm |
| 13 | 6 | 10 | Several nm |
| 14 | 6 | 15 | Several nm |

No formation of fogging on the glass sheet is observed in any of the fourteen tests.

1. A method comprising applying a monolithic transparent substrate for separating a chamber cooled to a temperature of 0 to 4° C. from an ambient atmosphere, wherein a face of the monolithic transparent substrate in contact with the cooled air is provided with a low-emissivity layer, and another face of the monolithic transparent substrate in contact with the ambient atmosphere is provided with an anti-condensation layer.

2. The method as claimed in claim 1, wherein the anti-condensation layer comprises at least one of the polymer materials selected from the group consisting of polyurethane, polyacetal, polyester, poly(vinyl alcohol), poly(acrylic acid), polyethylene glycol, polypropylene glycol, polyol, polyvinylpyrrolidone, polyvinylpyridine, polyacrylate, polyacrylonitrile, polyacrylamide, polyacrolein, poly(vinyl acetate), silane or a copolymer of several of these, alone or as a mixture of several thereof.

3. The method as claimed in claim 1, wherein the anti-condensation layer is based on polyurethane.

4. The method as claimed in claim 1, wherein the anti-condensation layer comprises a polyurethane matrix with which polyvinylpyrrolidone molecules are interpenetrated.

5. The application as claimed in claim 1 wherein the anti-condensation layer has a thickness of between 5 and 80 μm.

6. The method as claimed in claim 1 wherein the anti-condensation layer forms the free main surface of an anti-fogging adhesive film.

7. The method as claimed in claim 1, wherein the substrate is made of mineral glass material or organic polymer.

8. The method as claimed in claim 5, wherein the anti-condensation layer has a thickness of between 10 and 70 μm.

9. The method as claimed in claim 8, wherein the anti-condensation layer has a thickness at most equal to 70 μm.
